(19) United States
(12) Patent Application Publication
(10) Pub. No.: US 2006/0094422 A1
(43) Pub. Date: May 4, 2006

(54) Internal cavity surveillance system (ICSS)

(76) Inventor: Anthony Lloyd Crooks, Chicago, IL (US)

Correspondence Address: Anthony L. Crooks, P.O. Box 268038, Chicago, IL, 60626, US

(21) Appl. No.: 10/801,157

(22) Filed: Oct. 18, 2004

(51) Int. Cl. H04Q 7/20

(52) U.S. Cl. 455/431; 340/425.5; 455/345

(57) ABSTRACT

This document will describe and relate a new, improved, and innovative “virtual” all-inclusive system/process of total connectivity. This connectivity can be achieved under the umbrella of my invention titled Internal Cavity System (ICSS). The object here is to improve/combine these components—as well as creating new products to enhance ICSS's development—into a single engine in which users will be able to make the most efficient use of their time. An example of ICSS would be for an individual to phone his/her residence (or into the main controls of ICSS) and give commands to an appliance. This is an example of what will become the future “Common Civilian Usage (CCU)” of this system. Another such usage would allow pilots of an in-flight aircraft to maintain real-time audio/visual contact of any/all parts of the craft as well as authorized ground crews having this same access. ICSS would also allow industries such as these to be able to capture, store, and retrieve data collected for any/all strategic reasons.

This document contains information regarding seeking and petitioning protection from the U.S. Patent Office for the development and implementation of this new and innovative communications system which I have named, “Internal Cavity Surveillance System (ICSS).” In the following sections I will elaborate on this entity

### CROSS-REFERENCE TO RELATED APPLICATIONS

Not Applicable

### STATEMENT REGARDING FEDERALLY SPONSORED RESEARCH OR DEVELOPMENT

Not Applicable

### REFRENCE TO SEQUENCE LISTING, TABLES, OR COMPACT DISK APPENDIX

### Not Applicable

### BACKGROUND OF INVENTION

1. Field of Invention

This invention pertains to the subject matters of remote communications and surveillance. These two entities are combined and addressed efficiently with the use and implementation of my ICSS concept. This ICSS entity functions with the use of transmitting visual data, information technology related hardware/software, as well as being a well-refined information system to be used tactical both for commercial and civilian use.

2. Description of the Related Art

This invention is to address such problems as not being able to achieve audio/visual contact with passengers (or the compartments of the same craft/vehicle) while in-transit to their destination(s). ICSS also will address the problem, such as motor vehicle drivers, not being able to view hard-to-see areas on/in their vehicle while they are driving. ICSS will address the problem of not being able to “see” inside of a stationary place (i.e. home, office, and etc.) until one physically arrives.

In the current state of technology, entities such as I.T., I.S., surveillance equipment, and wire-less audio contact are not being applied to other areas of communication(s) as I am attempting to address. These three separate entities (as well as others) are very much far along in the mature stages of their product life cycles or ideologies. There is now a need to elevate these items to the next level of productivity via amalgamating them into one creative process/system namely ICSS.

### BREIF SUMARY OF THE INVENTION

The intended object of this invention is to create and facilitate the integration of visual contact with that of audio, Informational Technologies, and Informational Systems to maintain contact with persons and property not in the same proximity/area. The advantages of this invention would include being beneficial in the areas of improving safety, convince, peace of mind; strategic and tactical uses, business to business and business to consumer applications; there are many advantageous applications awaiting to be deployed.

ICSS will solve problems, such as stipulated in the “BACKGROUND OF INVENTION”, by empowering individuals to be in control of potential situations by being “virtually” aware of the subject matter not in their immediate presences. If there exist any matter that needs addressing, the user will be able to execute “remote” or “voice” commands aimed at achieving their various needs, wants, or objectives.

### BRIEF DESCRIPTION OF THE SEVERAL VIEWS OF THE DRAWING

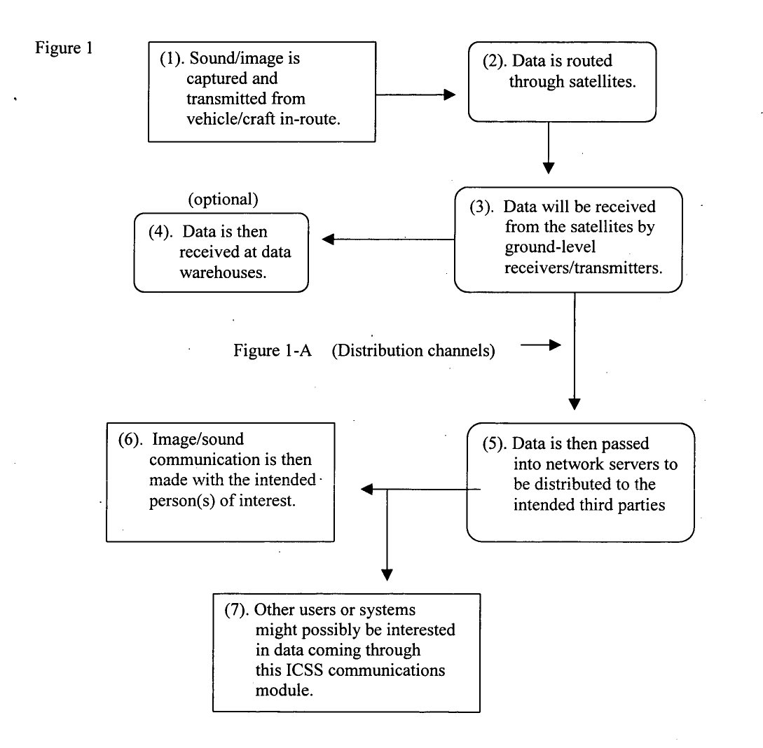

Although exact drawings are not applicable to this process, a flow chart out-lining the ICSS process is included. This flow diagram (see FIG. 1, pg. 10) does not exclude other possible orientations that will prove to be an optimum design for efficiency. The basic inference of this flow-diagram is how data is captured and the related channels it will travel through in order to reach its' intended third party sustaining audio/visual contact with the on-board individual(s).

This ICSS flow-diagram will also be applicable in the reverse order; the same communicative actions initiated at point (1) and carried to point (7), is true of the reverse. This will support the dual-access, two-way communications, or multiple inter-connections of individuals in transit or stationary.

### DESCRIPTION OF THE PREFERRED EMBODIMENT

As eluded to earlier, ICSS is a communications related system that allows two-way or multiple parties to be in virtual contact while one or several of them are in-transit. This system also incorporates viewing one's living quarters while not being on the premises. With the instillation of the prescribe equipment in the vehicle and on the premises, a motorist will be able to view the inside/outside of his/her premises before they arrive on the scene. In addition, a motorist will be able to “see” inside their trunk areas, a locked glove compartment, under the hood of the vehicle, under the car, immediately behind rows of seats (as applicable to SUV's, vans, and etc), while they are driving or from a remote location. Depending on the amount of cameras desired by the consumer, the related equipment will be pre-tuned to these high-tech panoramic cameras located in their strategic locations (home, car, office, etc). Also, depending on the desired want, the related equipment will contain audio capabilities to accompany the visual aspect. For general purposes, related equipment can be defined as a personal computer, home based television set hooked-up to the proper controls, or any hand-held device to be prescribe; a vehicle's sound system and mounted television set will also suffice for this process

Possible business aspects of ICSS is for firms to allow controlled customer/client real-time audio/visual contact with its' facilities or point-of-sales (ware-houses, managers, sales representatives, show rooms, and etc.). This contact will be facilitated by ICSS in allowing virtual/integrated communication from and to any moving or stationary entity. As pertaining to the September 11 attacks, if ICSS was in place, ground personnel would have been able to see and hear the events that were unfolding on-aboard those vessels that day. Information gather by ICSS would have been of great tactical use to law enforcement personnel on the ground; possibly mitigating/resolving situations occurring onboard. These are but a few areas that will be addressed, resolved, and facilitated with my development and deployment of this system. There are a myriad of commercial applications as that of the latter mentioned; these would include railways, cruises lines, bus-lines, and etc; these crafts/vehicles will be able to maintain virtual contact with their bases and vice-a-versa. The mentioned industries can strategically set up audio/video portals/terminals which can be used to view passengers, areas, or sections of the craft that is in-transit; captured images will be relayed either in real-time streams or otherwise.

Also, of the above industries, other compartments of the in/out bound craft can be viewed: this would include baggage areas/compartments, motor/engine compartments, and other inaccessible areas of the in-transit craft will be able to be viewed for the purpose of aiding and assisting those on-board in cases of emergency; as mentioned, viewing can be for non-emergency inquiring purposes. A potential tactical use would be that for a team of surgical specialists to communicate, in real-time, while some of them are not physically in the operating room. This will allow for medical schools, hospitals, and clinics to extol the expertise of their doctorial staff to areas were their various skills are needed by allowing them to see, hear, and extend advice relevant to procedures as they transpire.

ICSS is unique and differentiated from any other “security” related entity because there exists no system that is fit for such a broad scope/range of civilian and commercial usage as I have described ICSS to be. It's tactical advantages, along with improvements in the way businesses and governments will eventually conduct their operations, are limitless. Instead of the old way of going on-line and looking to see if a store has an item in stock, customers will be able to log into a stores “Virtual Shopping Network (VSN)” and “follow” the sales representative around the store for alternative products; this is accomplish by the use of lasers that “lock” onto the sales representative (the intended target of that particular communication), in conjunction with audio head-sets, we see a return to a more quality sort of buying experience. In addition, sales reps could be out-fitted with ICSS communication devices that facilitate a real-time shopping experience (two audio/visual contact with customers). This will give rise in opportunities for firms to make increased sales pitches to their “virtual” shoppers “entering” the store; manufactures will be ecstatic with their potential consumers being increasingly exposed to sales promotions and other marketing schemes. In another scenario, stores will hire more sales representatives to keep up with the demand of “shoppers” who are communicating in virtual real-time from around the block, corner, neighborhood, city, even across the country, or around the world. ICSS will become the next major foundation/principal on which businesses will incorporate into their sustainable competitive strategy; this will be the future business trend because the new paradigm today is, “ . . . the customer is more valuable than our products . . . . ”

As previously stated, the parts encompassing ICSS are that of a fully integration of I.T. and I.S. hareware/software, satellite connectivity, sensors and motion detectors, network systems, laser technology, fiber optical hardware, cable, DSL, High Definition technology, mico-sized high-tech/resolution surveillance cameras (these cameras must be of titanium quality to be able to withstand extreme conditions and usage). Other additional optional components would include voice control/recognition; this will be used in areas such as giving remote voice “commands” (i.e. telling something what to do!); also, mobile phones will be included in this system/process. These are but a few of the potential parts needed in the initial stages; as ICSS grows and consumer need arises, so will the scope and breath of its' components.

The best mode contemplated by me in carrying out this inventions is to first obtain a patent from the U.S. Patent Office for ICSS; I will then seek and solicit the sponsorship/support from various major U.S. retail corporations who exhibit strong tendency of investing in I.T. related concepts. These will be companies who are looking to get and maintain an edge over their competitors. Another strategy would include soliciting the airline manufacturing industry regarding prototyping of such a system to be released to the market. At the present time, I am in consortium with legal counsel in whom I will be working with to devise a final plan of action.

As pertaining to the Flow Diagram (FIG. 1, pg. 11), this diagram is laid out in its'basic seven steps; these steps are the general flow of actions being taken by the ICSS. The seven steps will be described as followed: (FIG. 1-1) This is the initial contact point of interest; a motorist in-bound to their residence can “look” into the refrigerator to see what items are need for the evening. The equipment mounted in/on this home appliance will be “on-line” to the main operating system that is installed in this person's holistic ICSS set-up. (FIG. 1-2) This diagram depicts the transmission of data from the intended subject via a hub (i.e. satellites, routers, and etc); (FIG. 1-3) the data will then be received by ground/sky level receivers as a possible first point of collection before further transmission—this is similar to how cell-phone technology operates. (FIG. 1-4). This optional step is gear towards businesses/governments who are interested in maintaining and ware-housing data for purposes such as training, marketing activities, law enforcement, safety concerns, and etc. (FIG. 1-A) This figure shows the possible ground, under-ground, or under-water distribution(s) channels needed as to facilitate this process; channels would include optic cables, Local Area Networks and Wide Area Networks, cable lines, Wire-less Segmentation Broadcasting, and etc. (FIG. 1-5) At this point, the data passes into network servers where their software manipulates, sanitizes, converts, and other assortments of digital actions or functions needed/requested by the commands/programs of its' users. After the required/intended actions are taken by the servers, (FIG. 1-6) the highly encrypted data is then delivered to its' intended third party; this also represents a successfully established real-time audio/video communication (if real-time is intended/desired). As an example, a third party person in this scenario would be able to use their mobile phone as a receiver of audio and video-streams from their source. (FIG. 1-7) The last step would include all those other parties who might have a tactical stake in these transmitted data being sent via ICSS. Data will be encrypted as “commercial” or “civilian” data as to ensure privacy rights and the highest level of security of persons' identity. As stated, the reverse of this order is also true to facilitate the real-time component of ICSS.

Another configuration would be to have direct satellite connection to the intended party; this would entail a route of steps 1, 2, 6. There are all too many configuration possibilities and benefits that ICSS will delivery to the market place.

1. What I claim as my invention is this communications process/system—ICSS—that supports and commends real-time two-way audio/visual in areas such as facilitating contact between individuals (including compartment areas, vital or non-vital inner section(s) of a moving vehicle/craft, in transit or routed to its' destination) and third party individuals, place, thing, or other systems not onboard.
ICSS allows both for general audio/visual communications as well as for high or low-level security surveillance purposes designated for civilian and commercial use. In addition, ICSS is applied to the concept of the possible “total connectivity” of everything and everybody; this is total connection of people/business to their property and each other. “Total connection” can be defined as “virtual” communication in real-time (i.e. audio/video); ability to give remote “command(s)” to objects to do or not to do a task (via voice or data entry i.e. touch-tone); and, the ability to capture, store, organize, and utilize this data for future usage.
ICSS will combine/consolidate all modes of communication into one operative entity. This is the case because ICSS will facilitate all communication and contact possibilities by incorporating the best attributes of other forms of communication while creating new systems, tools, and processes to expand the scope and usefulness of this invention.
